(19) United States
(12) Patent Application Publication
(10) Pub. No.: US 2026/0133841 A1
(43) Pub. Date: May 14, 2026

(54) UTILIZING AVAILABLE DPU MEMORY FOR GPU PROCESSED WORKLOADS

(71) Applicant: MELLANOX TECHNOLOGIES, LTD., Yokneam (IL)

(72) Inventors: Manjunath Gorentla Venkata, San Ramon, CA (US); Rohit Zambre, Seattle, WA (US); Yu Chang, Camas, WA (US); Sreeram Potluri, Milpitas, CA (US)

(21) Appl. No.: 18/944,948

(22) Filed: Nov. 12, 2024

(51) Int. Cl. G06F 9/50

(52) U.S. Cl. CPC G06F 9/5044; G06F 9/5016; G06F 2209/5011; G06F 2209/509

(57) ABSTRACT

Approaches presented herein provide for the reduction of workload bottlenecks during processing by offloading workload data to available data processing unit (DPU) memory, such as from graphics processing unit (GPU) memory or central processing unit (CPU) memory. Interfaces may be used to store the workload data to the pool of DPU memory, such as double data rate (DDR) memory, on-board non-volatile memory express (NVMe) devices, or NVMe devices over fabric. Interfaces may also be used to retrieve identified workload data required to complete a workload. The retrieved workload data may be provided to the GPU where the workload is completed. The pool of DPU memory may orchestrate transfers of the workload data. The workload data may be offloaded to the pool of DPU memory for training of a machine learning model. The workload data offloaded to the pool of DPU memory for training of a machine learning model may include model states, activation functions, or model checkpoints.

### TECHNICAL FIELD

At least one embodiment pertains to workload processing, including systems and methods for managing memory for the workload processing. In at least one embodiment, such workload processing can be managed by accessing DPU offered memory.

### BACKGROUND

Computation workloads, such as artificial intelligence (AI) training and high-performance computing (HPC) workloads, may be memory-capacity bound, requiring more memory but not necessarily more compute power. More memory can be added transparently to a distributed system by including more compute nodes, however compute nodes are expensive and the workloads do not benefit from additional compute resources. For AI training, certain aspects, such as model states, residual states, and checkpointing require enormous amounts of memory. Current AI frameworks attempt to solve the memory overheads of model states and residual states using techniques like memory offloading and activation recomputation, respectively. These techniques, however, face certain limitations. Activation recomputation incurs additional computation which hurts training performance. Memory offloading in AI frameworks is limited to memory capacity available on the node, including central processing unit (CPU) memory and on-board non-volatile memory express (NVMe) memory. There is also a growing need for fault-tolerance during AI training and HPC workloads given the decreasing Mean Time to Failure (MTTF) of newer systems. HPC and AI frameworks currently enable fault tolerance by checkpointing snapshots of a program state to storage devices. Such a solution, however, faces inflated costs in both writing and reading checkpoints due to the high latencies in accessing the storage devices.

### BRIEF DESCRIPTION OF THE DRAWINGS

Various embodiments in accordance with the present disclosure will be described with reference to the drawings, in which:

FIG. 1 illustrates an example computing environment in which offloading to available memory can be performed, in accordance with at least one embodiment;

FIG. 2 illustrates an example system for utilizing DPU resources for GPU processed workloads, in accordance with at least one embodiment;

FIG. 3A illustrates an example system for transferring workload data using interfaces, in accordance with at least one embodiment;

FIG. 3B illustrates an example system for transferring workload data using interfaces, in accordance with at least one embodiment;

FIG. 4 illustrates an example process for offloading workload data using DPU offered memory, in accordance with at least one embodiment;

FIG. 5 illustrates an example process for restarting machine learning model training from a checkpoint using DPU offered memory, in accordance with at least one embodiment;

FIG. 6 illustrates components of a distributed system that can be utilized to update or perform inferencing using a machine learning model, according to at least one embodiment;

FIG. 7 illustrates an example data center system, according to at least one embodiment;

FIG. 8 illustrates a computer system, according to at least one embodiment;

FIG. 9 illustrates a computer system, according to at least one embodiment;

FIG. 10 illustrates at least portions of a graphics processor, according to one or more embodiments; and

FIG. 11 illustrates at least portions of a graphics processor, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles, semi-autonomous vehicles (e.g., in one or more advanced driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational artificial intelligence (AI), generative AI with large language models (LLMs), light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations using LLMs, systems for performing light transport simulation, systems for performing collaborative content creation for 3D assets, systems implemented at least partially using cloud computing resources, and/or other types of systems.

Approaches in accordance with various embodiments are directed toward workload processing resilience, such as graphics processing unit (GPU)-based AI training resilience. Specifically, various approaches are directed toward a system memory expansion solution for scaling workloads, such as AI training and high-performance computing (HPC) workloads. A system, such as a distributed system, for processing such workloads may include one or more GPUs to perform at least part of the processing. The GPUs may be associated with a pool of data processing unit (DPU) memory, which may be provided using one or more DPUs. During the processing, values produced that are typically stored in memory associated with the GPU may be stored in the pool of DPU memory. In an example, a pool of DPU memory may also be responsible, at least in some instances, for transferring the values. In another example, a pool of DPU memory may include local or networked memory accessible by the DPUs. In order to transfer the values, object-store interfaces may be generated or defined between the DPU and other components, such as the GPU or central processing unit (CPU). For example, an interface such as an Application Programming Interface (API) may be used to assign identifiers to the values, insert values, fetch values, or perform collective-style operations. During processing, required values may be retrieved or selected from the pool of DPU memory and provided to other components, such as the GPU.

Various systems and methods enable providing additional memory capacity to distributed system configurations capable of AI training by utilizing the existing pool of DPU memory, removing the need to add memory, such as with more GPUs, to the distributed system configurations. At least one embodiment may offload model states from the GPU memory to the pool of DPU memory during AI training. In another embodiment, activation functions may be offloaded from the GPU memory to the pool of DPU memory during AI training. In another embodiment, model checkpoints may be offloaded from the GPU memory to the pool of DPU memory during AI training. If the AI training fails, the most recent model checkpoint can be retrieved from the pool of DPU memory and the training can be restarted from the model checkpoint. In an embodiment, the pool of DPU memory used to offload workload data may be scaled to reduce memory capacity loads on the GPUs for individual workloads or during the processing of a workload. Systems and methods may therefore overcome problems with existing system memory expansion techniques that often lead high GPU loads, latency, and suboptimal system configurations.

Variations of this and other such functionality can be used as well within the scope of the various embodiments as would be apparent to one of ordinary skill in the art in light of the teachings and suggestions contained herein.

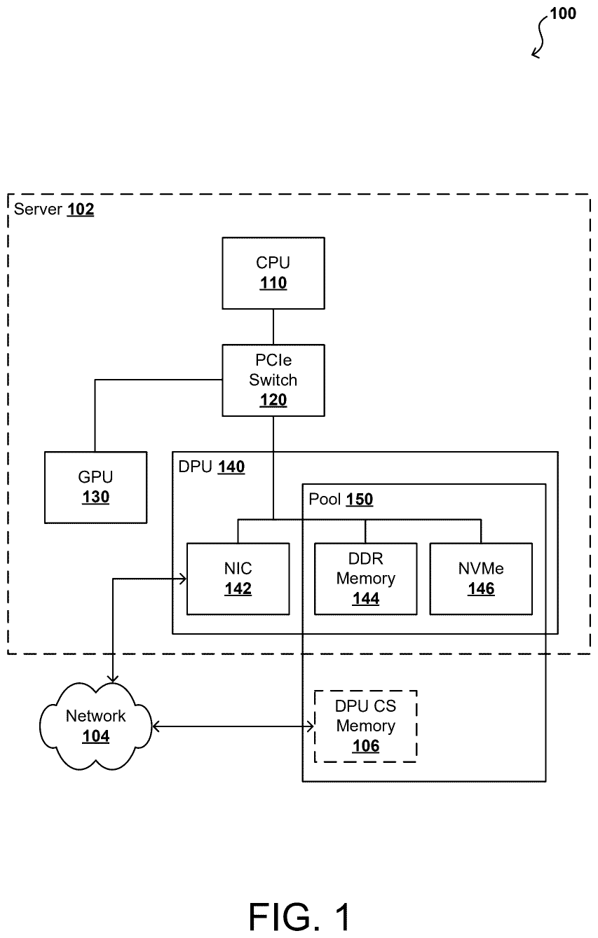

FIG. 1 illustrates an example computing environment 100 in which forward pass offloading to available memory can be performed, in accordance with at least one embodiment. It should be appreciated that embodiments of the present disclosure may also be used with reference to alternative environments and that specific discussion of components may be provided by way of non-limiting example and may include equivalents. Moreover, various features have been removed for clarity and conciseness. Additionally, systems and methods may be used with a variety of different architectures. The example computing environment 100 may include a server 102 which may be used to perform HPC workloads, such as AI training or machine learning model training. In an embodiment, the server 102 may be an application instance or a compute node. The server 102 may include a CPU 110 associated with a switch 120, such as a peripheral component interconnect express (PCIe) switch, which may control at least some data transmission over communication paths interconnecting various components. In an embodiment, the CPU 110 may include a root complex processor.

The PCIe switch 120 may also be associated with a GPU 130 and a DPU 140, and may transmit data between at least some of the CPU 110, the GPU 130, the DPU 140, and other components. In an embodiment, the PCIe switch 120 may be associated with more than one GPU or more than one DPU. In another embodiment, the PCIe switch 120 may be located within the DPU 140. The PCIe switch 120 may manage the transfer of at least some data between the CPU 110, the GPU 130, and the DPU 140. In another embodiment, the number of GPUs associated with the PCIe switch 120 may be equal to the number of DPUs associated with the PCIe switch 120. In at least one embodiment, the server 102 may include, without limitation, any number of the CPUs 110, the PCIe switches 120, the GPUs 130, and/or the DPUs 140, in any combination. For example, in at least one embodiment, server 102 could include eight, sixteen, thirty-two, and/or more GPUs 130. In at least one embodiment, communication paths interconnecting various components, including but not limited to the CPU 110, the PCIe switch 120, the GPU 130, and the DPU 140, in FIG. 1 may be implemented using any suitable protocols, such as peripheral component interconnect (PCI) based protocols (e.g., PCIe), or other bus or point-to-point communication interfaces and/or protocol(s), such as NV-Link high-speed interconnect, or interconnect protocols.

The DPU 140 may include a network interface card (NIC) 142, a DDR memory 144, and a non-volatile memory express (NVMe) device 146. The NIC 142 may be able to interface with a network 104, which may also interface with additional NVMe devices available to the DPU 140, such as over fabric. In an embodiment, the DPU 140 may not include the NVMe device 146. In another embodiment, the NVMe device 146 may be located on the server 102 and not on the DPU 140. In yet another embodiment, the computing environment 100 may include more than one of the NVMe device 146, such as a first NVMe device in the DPU 140 and a second first NVMe device on the server 102 an associated directly with the PCIe switch 120. In an embodiment, the DPU 140 may not include the DDR memory 144 and may include a computational storage services (CSS) in place of, or in addition to, the DDR memory 144. For example, computing environment 100 may include DPU computational storage (CS) memory 106 available to the DPU 140 as part of the CSS. The network 104 may be able to interface with the DPU CS memory 106 through the NIC 142, according to any suitable interface protocol, such as remote direct memory access (RDMA) over Ethernet, InfiniBand, Fiber Channel, etc.

The total memory of the computing environment 100 available for data storage may be expanded through the use of the DPU 140 on nodes of the system. The DPU 140 may have access to a pool 150 of memory already available to the server 102, such as double data rate (DDR) memory, on-board NVMe devices, NVMe devices over fabric, and CS. The pool 150 of memory may include at least one of the DDR memory 144, NVMe 146, and the DPU CS memory 106. The DPU 140 may also be able to access the available memory of other DPUs as part of the pool 150, and other DPUs may be able to access the available memory of DPU 140, such as the pool 150. This available memory can be accessed and utilized for data storage, without the addition of compute resources, such as compute nodes, which would be required using other solutions. The available pool 150 accessible to the DPU 140 may be provisioned for the server 102 to expand the total memory available for data storage, such as to reduce the data storage load on the CPU 110 or the GPU 130, which can instead increase the utilization of their memory for processing. For example, during training of an AI, the model states, residual states, activation functions, and checkpoints can be stored, or offloaded, on the pool 150 accessible to the DPU 140.

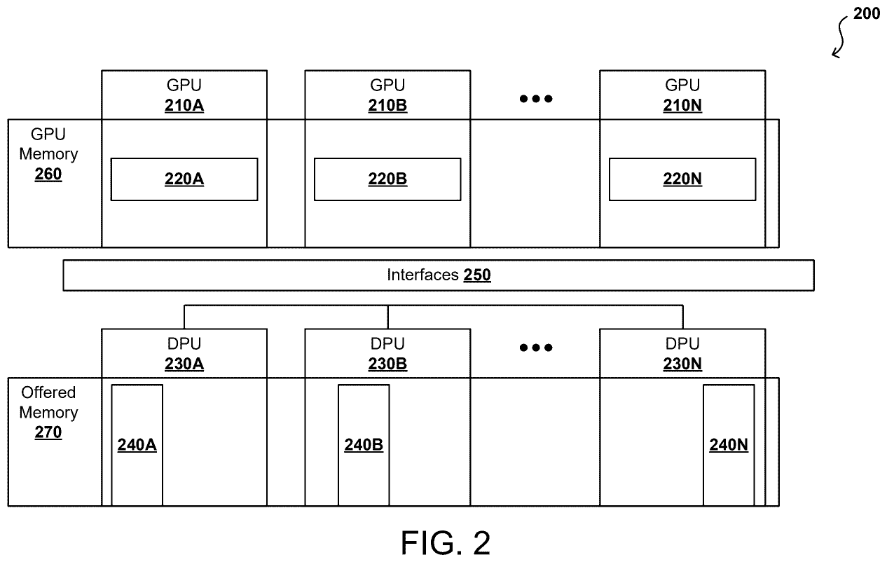

Offloading workload data and orchestration to the DPU 140 instead of the CPU 110 allows for improved performance since the CPU 110 may be shared across multiple GPUs, while the number of DPU on a server may be equal to the number of DPUs on a server. Since distributed system often include a DPU for every GPU and each GPU writes to its own DPU, GPUs does not face contention when writing to DPU, whereas contention would be present when writing to a shared CPU. The memory offloading capacities of the CPU 110 may also be limited to the NVMe capacities on the node. The DPU 140 may also reduce the idle latency caused by storing data on the NVMe capacities on the node using the CPU 110 or the GPU 130, since the DDR memory 144 may be DDR memory with lower latency. Additionally, while the memory capacity of the GPU 130 is limited to the memory located on the GPU 130, the DPU 140 has access to more pull-up memory by utilizing the NIC 142 to access more memory through the network 104. To offload workload or training data to the pool 150 accessible to the DPU 140, one or more object-store interfaces (described in more detail in FIG. 2) may be defined, which can be used to transfer data utilizing the pool 150 accessible to the DPU 140. In an example, as the GPU 130 processes a workload, data that may need to be referenced or used to complete the workload may be stored in the pool 150 accessible to the DPU 140 instead of being stored in the memory of the GPU 130. The GPU 130 may only interact with only an orchestrator that is prefetching from and offloading to the DPU 140, instead of orchestrating the offloading itself or interacting with additional orchestrators. By offloading to the DPU 140, details, such as network communication, cold storage, or other information, may therefore be abstracted away from the GPU 130. The orchestrator may control underlying details such as storage, network communication, prefetching, or other information, instead of the GPU 130.

A method of machine learning model training used to decrease resource usage is fully sharded data parallel (FSDP). However, the memory requirements using FSDP may still be large due to the size of model states, residual states, training configurations, and Fault tolerance requirements. The model states, as shards and layers, may include at least weights, parameters, or optimizers. The residual states may include at least activation functions. The training configurations may include at least batch size, pipeline interleaving factor, or data parallelism dimension. The fault tolerance requirements may include at least checkpoint stores. On the server 102, the available memory of the GPU 130 may be too close to the compute to be optimal and the available memory of the CPU 110 may be far from the compute but may be preoccupied, while the pool 150 available to the DPU may be far from the compute and close to network 104.

As traditionally used, FSDP may utilize sharded data parallelism as a type of data parallelism that splits parameters across GPUs in a data parallel group. Sharded data parallelism can be used to shard a model's training state and reduce the memory footprint per GPU. However, the GPU 130 memory is being used for both storage and working memory. Additionally, the GPU 130 streaming multiprocessors (SMs) may be used for communication instead of compute, which is less than optimal. Since the GPU 130 does not need memory for a layer until that layer is currently processed, or hot, and the DPU 140 is at least partially idle, the DPU 140 can be responsible for communication and storage of the layer. Therefore, the DPU 140 may act as a distributed parameter server to store the currently unused, or cold, model states, or other workload data, and orchestrate the required data movement, such as those related to parameters and gradients. In this example, the capacity and bandwidth loads on the GPU 130 memory components may be reduced for faster training configurations, the GPU 130 resources may be dedicated to compute processes since no SMs are involved in data movement, offloaded model states may transparently serve as checkpoints for resilient execution, and abstraction between GPU and DPU responsibilities may be more clear. Therefore, memory offloading to the DPU 140 can enable the overlap of data movement between cold and hot memories with communication on cold memory and computation on hot memory, as well as increasing workload processing efficiency. For example, memory offloading to the DPU 140 can increase efficiency and reduce performance bottlenecks in AI training methods including FSDP, model parallelism, mixture of experts (MoE), and other suitable processes.

During a forward pass of FSDP training as traditionally used, the GPU 130 may perform the weights read and write operations and communicate the weights, such as weight layers and shards, of a model stored on the GPU 130 through the NIC 142 to the network 104. However, by offloading the model states, including at least the weights and gradients, during a forward pass of FSDP training to the DPU 140, the DPU 140 may take over at least some of the weights read and write operations, as well as utilize the DDR memory 144 to communicate the weights stored on the DDR memory 144 to the GPU 130 and communicate through the NIC 142 to the network 104. Offloading the model states during a forward pass to the DPU 140 may enable optimized data movement by instead using the DPU 140 to take over only the weights read operations, as well as utilizing the DDR memory 144 to transfer the weights stored on the DDR memory 144 to the GPU 130 and transfer through the NIC 142 to the network 104. Since the DPU 140 is close to the network 104 and model states, or at least the weights and the gradients, may be required to be communicated over the network more frequently than most other workload data since the model states may be used during the forward and backwards passes and updated at the end of each iteration, the model states stored on the DDR memory 144 can be communicated with low latency. The weights and gradients may be continuously used each iteration of the AI training, and may be updated with each iteration. Offloading the model states during a forward pass of FSDP training to the DPU 140 may allow the model state to be initialized on the pool 150 available to the DPU 140 as the GPU 130 loads and stores the model states from the pool 150 available to the DPO 140, since the model states are not needed at the GPU 130 at all times.

The activation functions may also be offloaded to the DPU 140 during a forward pass. In another embodiment, both the model states and the activation functions may also be offloaded to the DPU 140. Activation functions are produced during the forward pass of the AI training and consume more memory than parameters and gradients, since activation sharding is limited to typically on-node while model sharding can go beyond a node. Activation recomputation is a traditionally used method that may reduce the memory requirements of residual states, or activation functions, at the expense of introducing more computation. However, the memory requirements of residual states may be addressed by offloading the activation functions to the pool 150 available to the DPU 140 and does not introduce the overhead of recomputation. By offloading the model states and the activation functions during a forward pass of FSDP training to the DPU 140, the DPU 140 may also have the activation functions written to the DPU 140 and the DDR memory 144 may also be used to communicate the activation functions stored on the DDR memory 144 between the GPU 130 as they are needed for processing. Offloading the model states and the activation functions to the DPU 140 may also enable optimized data movement.

During a backward pass of FSDP training as traditionally used, the GPU 130 may perform the weights and the gradients read and write operations and communicate the weights and the gradients stored on the GPU 130 through the NIC 142 to the network 104. However, by offloading the model states during a backward pass of FSDP training to the DPU 140, the DPU 140 may take over at least some of the weights and the gradients read and write operations, as well as utilize the DDR memory 144 to communicate the weights and the gradients stored on the DDR memory 144 to the GPU 130 and communicate through the NIC 142 to the network 104. Additionally, there may be no GPU buffers for the communications orchestrated by the DPU 140. Offloading the model states during a backward pass to the DPU 140 may enable optimized data movement by instead using the DPU 140 to take over limited portions of the weights and the gradients read and write operations, as well as utilizing the DDR memory 144 to transfer the gradients stored on the DDR memory 144 to the GPU 130 and transfer through the NIC 142 to the network 104.

The activation functions may also be offloaded to the DPU 140 during a backward pass. In another embodiment, both the model states and the activation functions may also be offloaded to the DPU 140. By offloading the model states and the activation functions during a backward pass of FSDP training to the DPU 140, the DPU 140 may also have the activation functions written to the DPU 140 and the DDR memory 144 may also be used to communicate the activation functions stored on the DDR memory 144 between the GPU 130 as they are needed for processing. Offloading the model states and the activation functions to the DPU 140 may also enable optimized data movement.

In order to improve fault tolerance during AI training, checkpoint reset may be performed to enable training resilience. As traditionally used checkpoint restarts may retrieve checkpoints from disks or in-memory checkpointing using an in-CPU checkpoints, but both have limitations. Checkpoints stored in disks require high latency, especially when performed asynchronously, and checkpoints stored in CPU memory lacks resiliency because it is not a persistent location. Additionally, as traditionally used checkpoint restarts may require the checkpoint to be loaded and the entire training application to be restarted. However, the GPU 130 training may use a tiered solution including offloading the checkpoints, or model states, to the pool 150 available to the DPU 140, and may include writing the checkpoints to the pool 150, such as the DDR memory 144 or the DPU CS memory 106, and writing the checkpoints using the DPU 140 to persistent location, such as NVMe 146, NVMe over fabric, or other persistent devices. Offloading the checkpoints to the pool 150 available to the DPU 140 offers in-memory checkpointing as opposed to storage-based checkpointing in prior solutions. This solution provides fast access using the DDR memory 144 and resiliency using the persistent location. The checkpoints may include checkpoint shards as the portion of the model state in individual nodes, or processing elements. The checkpoint shards may include model states, or weights, gradients, and optimizer states of the model, and are checkpointed for fault tolerance, to allow to resume from the previous checkpoint when failure occurs. In an embodiment, the training application does not have to be restarted and only the individual failed training models, or training jobs, are restarted. The models being trained within a training application, such as on server 102, can be coordinated at saved, or synchronized, points during the training. Therefore, if training of one or more models fail, the training of the remaining models may continue and the training of the failure models can be restarted at the synced point from the checkpoint, which can be stored in the pool 150 available to the DPU 140. In an example, the model state offloaded to the DPU 140 can be sued to resume the training of a failed model by restarted from the closest synced point.

FIG. 2 illustrates an example system 200 for utilizing DPU resources for GPU processed workloads, in accordance with at least one embodiment. The example system 200 may process workload by including at least two GPU 210 and at least two DPU 230, which may be used to offload workload data from the memory 260 of the GPU 210 to the offered memory 270 of the DPU 230. The GPU 210 of the example system may include at least GPU 210A, GPU 210B, and GPU 210N. Other embodiments may include more or fewer GPU. The DPU 230 of the example system may include at least DPU 230A, DPU 230B, and DPU 230N. Other embodiments may include more or fewer DPU. Each of the GPU 210 may write to the offered memory 270 of the corresponding DPU 230, and each of the DPU 230 may be able to access the offered memory 270, including the individual memory of the other DPU 230.

While processing a workload on the system 200, the GPU 210 offloads workload data to the DPU 230, the offered memory 270 may act as a distributed server able to store the workload data, such as parameters, gradient, or other values. For example, FSDP may utilize sharded data parallelism as a type of data parallelism that splits parameters across GPUs in a data parallel group. Sharded data parallelism can be used to shard model training states into layers and reduce the memory footprint per GPU. However, since the GPU 210 does not need memory for a layer until that layer is processed by the GPU 210 as a working layer 220 in the GPU memory 260 and the DPU 230 may be idle, the DPU 230 may be responsible for communication of the working layer 220, or other data. One or more of the GPU 210A, GPU 210B, through GPU 210N may receive and process a corresponding working layer 210A, working layer 210B, though working layer 210N. The offered memory 270 may store workload data, including the working layers 220, as model shards 240. Each of the DPU 230A, DPU 230B, and DPU 230N can receive and process a corresponding model shards 240A, model shards 240B, and model shards 240N on the offered memory 270. The model shards 240 can be transferred from the DPU 230 to the GPU 210 to be processed as the working layers 220 on the GPU memory 260.

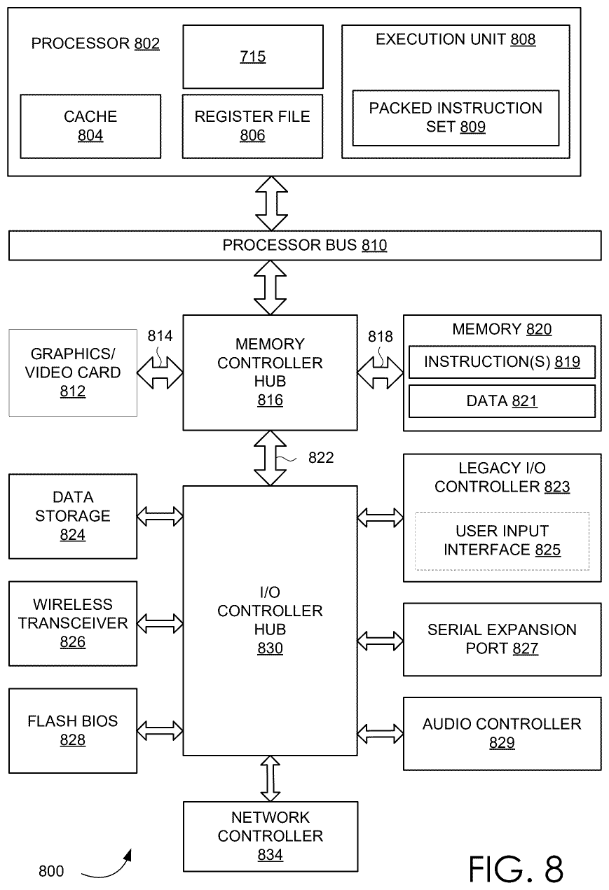

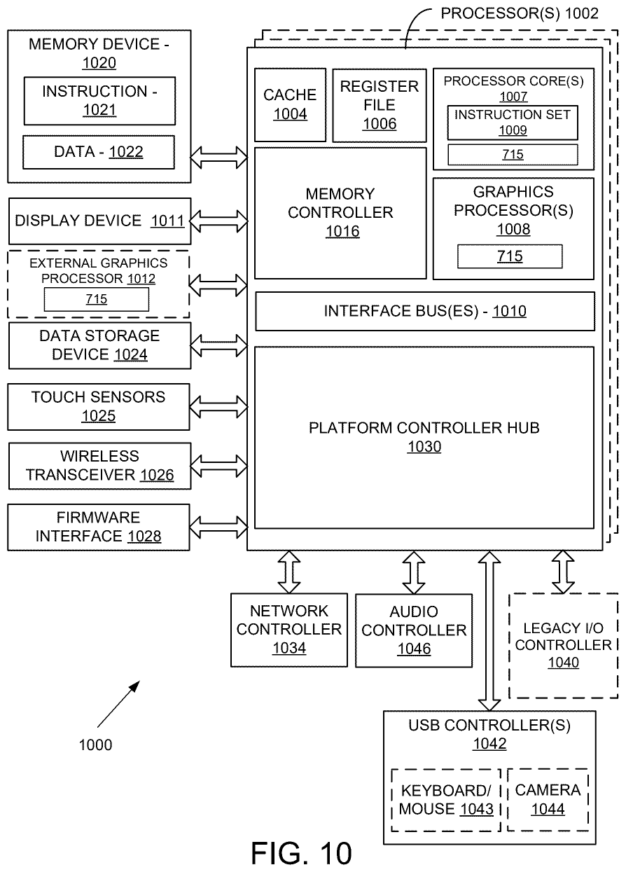

To transfer data, such as workload data or training data, between the offered memory 270 of the DPU 230 and the GPU memory 260, one or more object-store interfaces 250 may be generated or defined. The interfaces 250 may be defined between the DPU 230 and other components, such as the GPU 210, a CPU, etc., in order to assign identifiers to the values, insert values, fetch values, or perform collective-style operations. For example, the interfaces 250, such as an API, may be used to insert and fetch the data or portions of the data, such as shards, values, items, or other types. In an embodiment, the interfaces 250 may be implemented in one or more buses or interconnects, such as a processor bus, a peripheral bus, a memory busses, or a NV-Link interconnect. In an example, the processor bus, such as a version of a Direct Media Interface (DMI) bus, may be similar to the processor bus 810, illustrated in FIG. 8, that may transmit data signals between processor 802 and memory 820. In an example, the peripheral bus may be similar to the interface bus(es) 1010, illustrated in FIG. 10, that may include one or more PCI buses (e.g., PCI, PCe) transmit data signals. In an example, the NV-Link interconnect may transmit data signals between one or more components including GPUs, CPUs, DPUs, and other components, as well as individual ones of each component type. In order to transfer the data utilizing the DPU 230 offered memory 270, the interfaces 250 may assign identifiers to the data. A “put” API may be used by the interfaces 250 to insert a value into the offered memory 270 and define an identifier for that value. A “get” API may be used by the interfaces 250 to return the value corresponding to the identifier that was passed in, such as to the GPU 210. Additionally, the interfaces 250, such as an API, may be used to perform collective-style operations prevalent in AI training, such as allgathers and reduce-scatters on the distributed items within the offered memory 270. In an embodiment, model states and residual states, such as the shards 240, may utilize the offered memory 270 via memory offloading techniques. For example, model states may be at least initialized, allgathered, and/or reduce-scattered on the offered memory 270 using the interfaces 250. In an embodiment, activation functions, once computed during the forward pass, may be offloaded to the offered memory 270 of the DPU 230 using the “put” API and may be prefetched from the offered memory 270 using the “get” API when needed in the backward pass.

During AI training the interfaces 250 may be used to transfer checkpoints as workload data stored in the offered memory 270 in order to reduce the overhead loads associated with both saving a checkpoint and loading a saved checkpoint. The “put” API may be used by the interfaces 250 when saving checkpoints, and the “get” API may be used by the interfaces 250 to load stored checkpoints. Given the presence of DDR memory on the DPU 230, the access latencies to checkpoints on offered memory 270 may be lower than those on storage devices. This may also apply to checkpointing for HPC applications where the offered memory 270 is used for tiered-level checkpointing. For example, high frequency checkpoints in the offered memory 270 may overlap with lower-frequency transfers of in-memory checkpoints to storage devices. In an embodiment, one or more software stack or training framework may be aware of the offered memory 270 and may be used to keep track of the mapping of data, such as the shards 240 and the working layers 220, between the GPU 210 and the DPU 230. In another embodiment, an underlying communication packet may be aware of the offered memory 270 and may be used to keep track of the mapping of data between the GPU 210 and the DPU 230

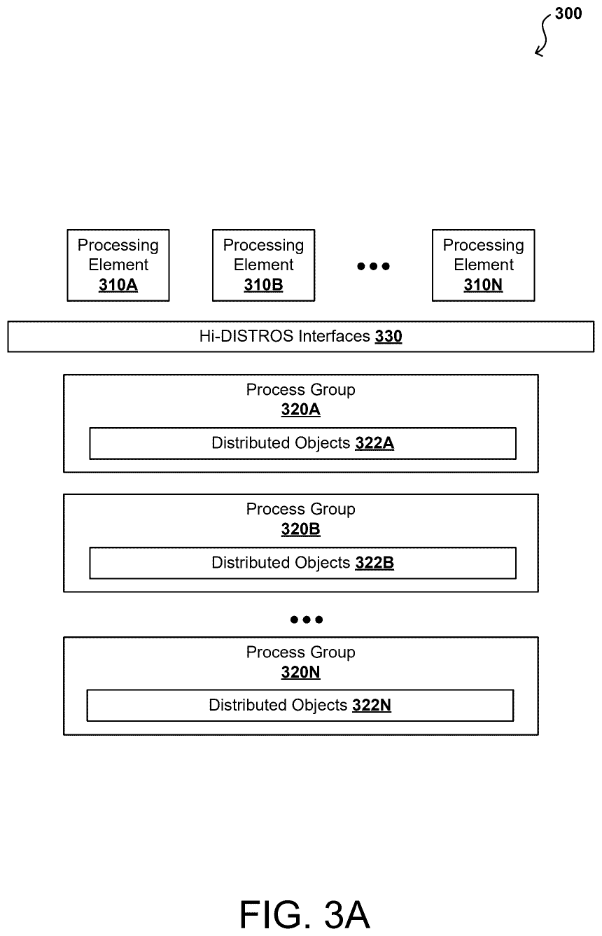

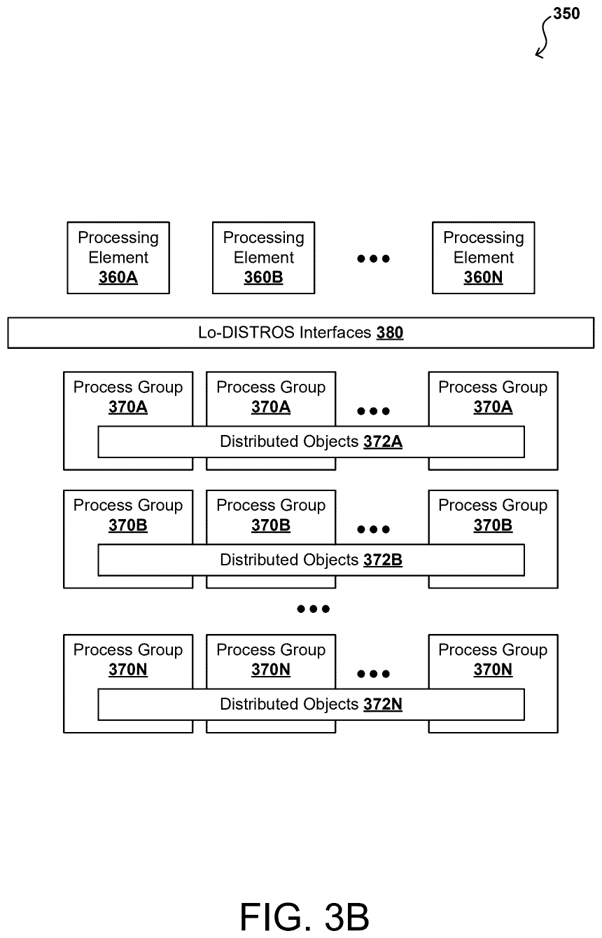

FIG. 3A illustrates an example environment 300 for transferring workload data using interfaces, in accordance with at least one embodiment. In this example, the environment 300 may transferring workload data by including a one or more process group high-level distributed object store (Hi-DISTROS) interfaces 330 between at least two processing element 310 and at least two process group 320, which may be used to scale the available memory utilizing DPU offered memory. The processing element 310 of the example system may include at least processing element 310A, processing element 310B, and processing element 310N. Other embodiments may include more or fewer processing element. The process group 320 of the example system may include at least process group 320A, process group 320B, and process group 320N. Other embodiments may include more or fewer process group. In another embodiment, the process group may be partitioned. A server, such as the example environment, may include the processing element 310 that represents host nodes which have DPUs attached, and may also include items, such as distributed objects 322, stored in the process group 320 on the DPU offered memory. Each of the process group 320A, process group 320B, and process group 320N may store a corresponding distributed objects 322A, distributed objects 322B, and distributed objects 322N. Other embodiments may include more or fewer distributed objects. Each of the distributed objects 322 may be associated with an identifier that can be used to fetch the distributed objects 322. The example environment 300 may include the Hi-DISTROS interfaces 330 to transfer the distributed objects 322 between the processing element 310 and the process group 320. The Hi-DISTROS interfaces 330 may enable high level functionality for the transfer of the distributed objects 322. The example environment 300 may also include one or more memory access interfaces, such as put, get, flush, gather, or other suitable interfaces. In an embodiment, the Hi-DISTROS interfaces 330 may not take specific processing element 310 as an argument. In another embodiment, the Hi-DISTROS interfaces 330 may allow for transparent data placement to a user where runtime is responsible for the data placement.

In an example, for training, such as using FSDP, of an AI as a workload, instead of model layers may be sharded on processing element 310, the model layers are on the process group 320 of the DPU offered memory as distributed objects 322. The processing element 310 may load the distributed objects 322 on the process group 320 of the DPU offered memory during a forward or backward pass using the Hi-DISTROS interfaces 330, such as allgathers. The processing element 310 may also update the distributed objects 322 on the process group 320 of the DPU offered memory during a backward pass using the Hi-DISTROS interfaces 330, such as with synchronous or asynchronous operations. Therefore, the updates and fetches for the training, or other workload processes, may be from the DPU offered memory instead of the GPU offered memory.

FIG. 3B illustrates an example environment 350 an example system for transferring workload data using interfaces, in accordance with at least one embodiment. In this example, the environment 350 may transferring workload data by including a one or more process group low-level distributed object store (Lo-DISTROS) interfaces 380 between at least two processing element 360 and at least two partitioned process group 370, which may be used to scale the available memory utilizing DPU offered memory. Similarly to FIG. 3A, the processing element 360 of the example system may include at least processing element 360A, processing element 360B, and processing element 360N. Other embodiments may include more or fewer processing element. Similarly to FIG. 3A, the partitioned process group 370 of the example system may include at least partitioned process group 370A, partitioned process group 370B, and partitioned process group 370N. Other embodiments may include more or fewer partitioned process group. In another embodiment, the process group may not be partitioned. A server, such as the example environment, may include the processing element 360 that represents host nodes which have DPUs attached, with items, such as distributed objects 372, stored in the partitioned process group 370 on the DPU offered memory. Each of the partitioned process group 370A, partitioned process group 370B, and partitioned process group 370N may store a corresponding distributed objects 372A, distributed objects 372B, and distributed objects 372N. Other embodiments may include more or fewer distributed objects. Each of the distributed objects 372 may be associated with an identifier that can be used to fetch the distributed objects 372. The example environment 350 may include the Lo-DISTROS interfaces 380 to transfer the distributed objects 372 between the processing element 360 and the partitioned process group 370. The Lo-DISTROS interfaces 380 may enable low or granular level functionality for the transfer of the distributed objects 372. Similarly to FIG. 3A, the example environment 350 may also include one or more memory access interfaces, such as put, get, flush, gather, or other suitable interfaces. In an embodiment, the Lo-DISTROS interfaces 380 may expose the partitions of the partitioned process group 370 based on the corresponding processing element 360, such as where each partition of the partitioned process group 370 corresponds to one of the processing element 360. In another embodiment, the Lo-DISTROS interfaces 380 may allow a user to be responsible for data placement. In an example, one or more of the Hi-DISTROS interfaces 330 of the Lo-DISTROS interfaces 380 may be used for one or more of the process that can be perform in the environment 100 illustrated in FIG. 1, such as activation functions offloading and evaluation, model state offloading and evaluation, or other suitable processes.

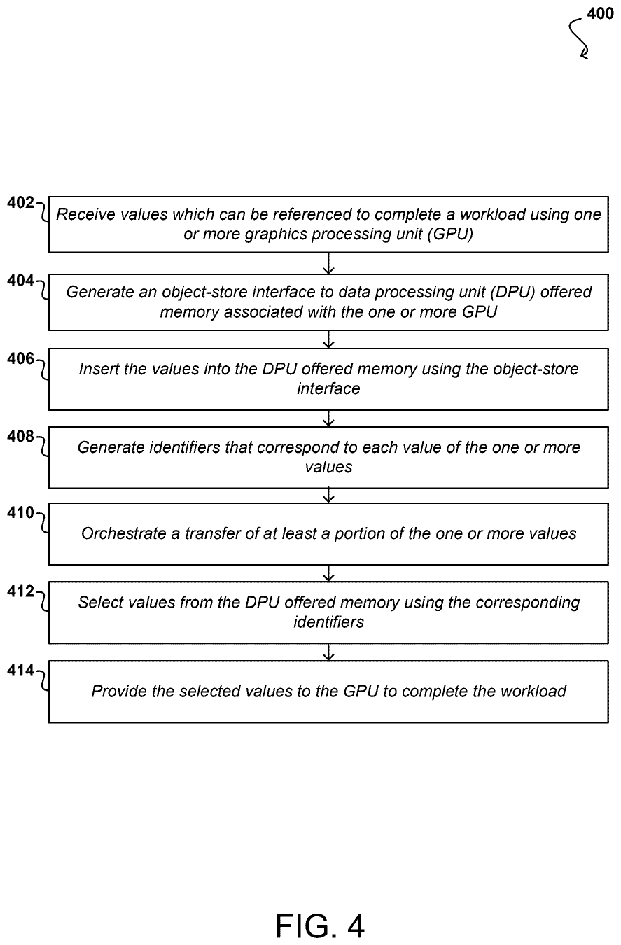

FIG. 4 illustrates an example process 400 for offloading workload data using DPU offered memory, in accordance with at least one embodiment. It should be understood that for this and other processes presented herein that there may be additional, fewer, or alternative operations performed in similar or alternative orders, or at least partially in parallel, within the scope of the various embodiments unless otherwise specifically stated. In this example, values may be received 402 which can be referenced to complete a workload using GPUs. The values may include items or specific model elements produced during training of a machine learning model. The values may include one or more of model states, activation functions, or model checkpoints. One or more of the values may be expected to be referenced with higher frequency than other values. The workload may be performed using processing elements representing nodes which are associated with DPUs. An object-store interface to DPU offered memory associated with the GPUs may be generated 404 to transfer the values. More than one interfaces may be generated to transfer the values or perform other actions. The interfaces may be Lo-DISTROS interfaces or Hi-DISTROS interfaces. The object-store interface may be able to transfer the values to more than one memory source of the DPU offered memory.

The values may be inserted 406 into the DPU offered memory using the object-store interface. The values may be stored as distributed objects, such as in process groups or partitioned process groups. The DPU offered memory may include DDR memory, on-board NVMe devices, or NVMe devices over fabric. The DPU offered memory may include a plurality of DPUs. Identifiers that correspond to each value of the one or more values may be generated 408 by the object-store interface. The identifiers may be generated by separate interface. The identifiers may correspond with portions of the values or groups of the values. The identifiers may be used to fetch the corresponding values. A transfer of at least a portion of the one or more values may be orchestrated 410 by the DPU offered memory. The transfer may be orchestrated at least in part by the CPU. The transfer may be performed at the same time as the GPU is processing the workload. The values from the DPU offered memory may be selected 412 using the corresponding identifiers. The values may be selected in order to complete the workload. The values may be selected individually or as part of a group. The selected values may be provided 414 from the DPU offered memory to the GPU to complete the workload. One or more Lo-DISTROS interfaces or Hi-DISTROS interfaces may provide the values. The values may be provided using a collective-style operation.

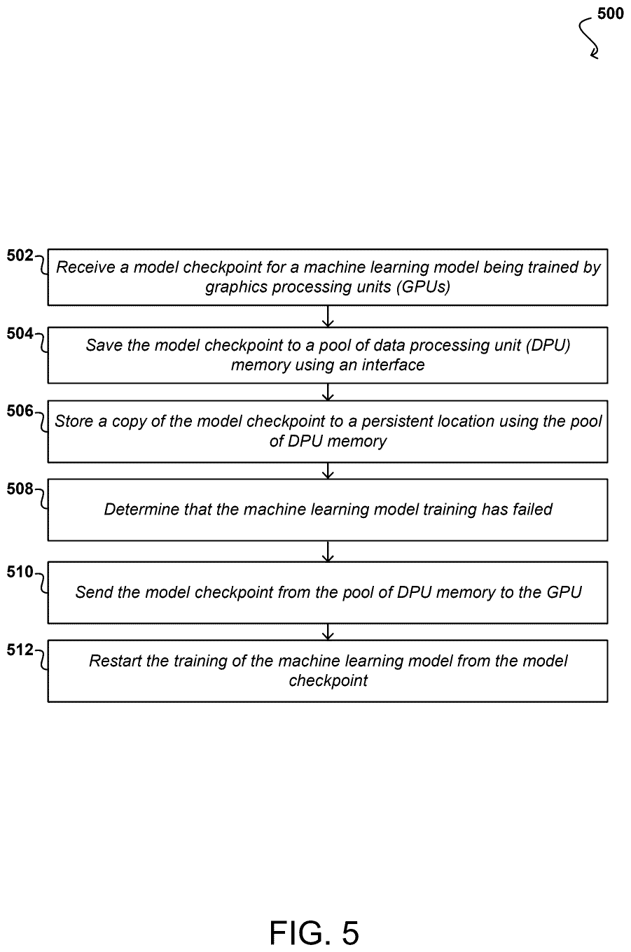

FIG. 5 illustrates an example process 500 for restarting machine learning model training from a checkpoint using DPU offered memory, in accordance with at least one embodiment. In this example, a model checkpoint can be received 502 for a machine learning model being trained by GPUs. The model checkpoint may include a model state. The machine learning model may be trained at the same time as other machine learning model by the GPUs. The model checkpoint may be received as a plurality of model shards. The model checkpoint may be saved 504 to a pool of DPU memory using an interface. The pool of DPU memory may include a number of DPUs equal to the number of GPUs on the system. The saved model checkpoint may be associated with a synced point available to more than one models being trained. A copy of the model checkpoint may be stored 506 to a persistent location using the pool of DPU memory. The DPU may orchestrate the storing of the copy to the persistent location. The storing of the copy may be performed asynchronously with the saving of the model checkpoint to the pool of DPU memory. The machine learning model training may be determined 508 to have failed. One of a plurality of machine learning models may have failed. More than one of the machine learning models may have failed. The model checkpoint may be sent 510 from the pool of DPU memory to the GPUs. An interface may be used to send the model checkpoint to the DPU. The model checkpoint may also be retrieved from the persistent memory. The model checkpoint may be sent as shards. The training of the machine learning model may be restarted 512 from the model checkpoint. The restart of the training of the machine learning model may not require the restart of the training application or the restart of other models being trained.

As discussed, aspects of various approaches presented herein can be lightweight enough to execute on a device such as a client device, such as a personal computer or gaming console, in real time. Such processing can be performed on, or for, content that is generated on, or received by, that client device or received from an external source, such as streaming data or other content received over at least one network. In some instances, the processing and/or determination of this content may be performed by one of these other devices, systems, or entities, then provided to the client device (or another such recipient) for presentation or another such use.

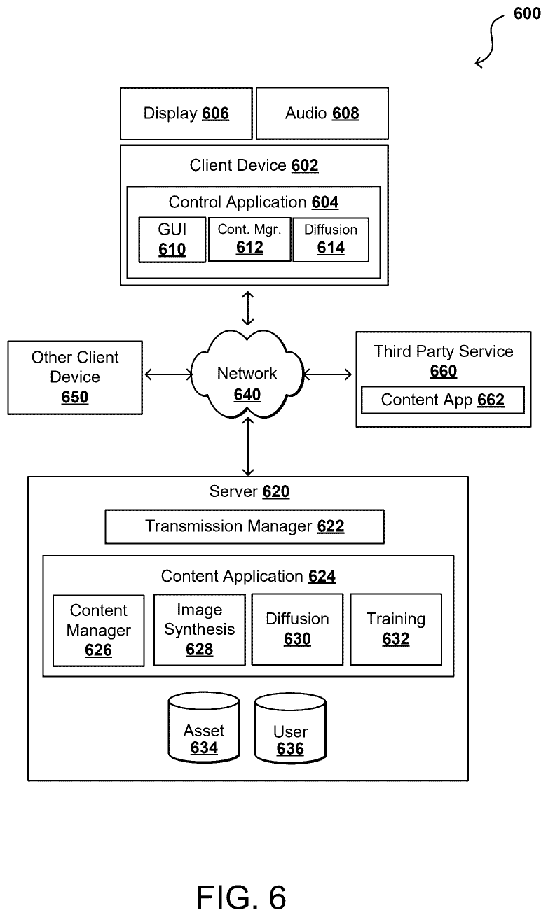

As an example, FIG. 6 illustrates an example network configuration 600 that can be used to provide, generate, modify, encode, process, and/or transmit image data or other such content. In at least one embodiment, a client device 602 can generate or receive data for a session using components of a control application 604 on client device 602 and data stored locally on that client device. In at least one embodiment, a content application 624 executing on a server 620 (e.g., a cloud server or edge server) may initiate a session associated with at least one client device 602, as may utilize a session manager and user data stored in a user database 636, and can cause content such as one or more digital assets (e.g., object representations) from an asset repository 634 to be determined by a content manager 626. A content manager 626 may work with an image synthesis module 628 to generate or synthesize new objects, digital assets, or other such content to be provided for presentation via the client device 602. In at least one embodiment, this image synthesis module 628 can use one or more neural networks, or machine learning models, which can be trained or updated using a training module 632 or system that is on, or in communication with, the server 620. This can include training and/or using a diffusion model 630 to generate content tiles that can be used by an image synthesis module 628, for example, to apply a non-repeating texture to a region of an environment for which image or video data is to be presented via a client device 602. At least a portion of the generated content may be transmitted to the client device 602 using an appropriate transmission manager 622 to send by download, streaming, or another such transmission channel. An encoder may be used to encode and/or compress at least some of this data before transmitting to the client device 602. In at least one embodiment, the client device 602 receiving such content can provide this content to a corresponding control application 604, which may also or alternatively include a graphical user interface 610, content manager 612, and image synthesis or diffusion module 614 for use in providing, synthesizing, modifying, or using content for presentation (or other purposes) on or by the client device 602. A decoder may also be used to decode data received over the network 640 for presentation via client device 602, such as image or video content through a display 606 and audio, such as sounds and music, through at least one audio playback device 608, such as speakers or headphones. In at least one embodiment, at least some of this content may already be stored on, rendered on, or accessible to client device 602 such that transmission over network 640 is not required for at least that portion of content, such as where that content may have been previously downloaded or stored locally on a hard drive or optical disk. In at least one embodiment, a transmission mechanism such as data streaming can be used to transfer this content from server 620, or user database 636, to client device 602. In at least one embodiment, at least a portion of this content can be obtained, enhanced, and/or streamed from another source, such as a third party service 660 or other client device 650, that may also include a content application 662 for generating, enhancing, or providing content. In at least one embodiment, portions of this functionality can be performed using multiple computing devices, or multiple processors within one or more computing devices, such as may include a combination of CPUs and GPUs.

In this example, these client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency can be reduced by enabling the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device, or may incorporate one or more Virtual Machines (VMs). In at least one embodiment, such a system can be implemented at least partially in a data center or at least partially using cloud computing resources.

### DATA CENTER

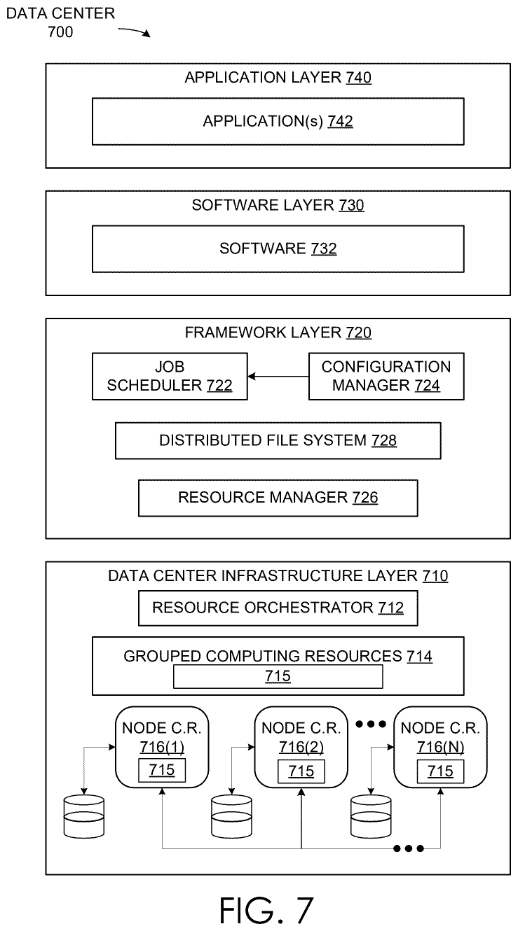

FIG. 7 illustrates an example data center 700, in which at least one embodiment may be used. In at least one embodiment, data center 700 includes a data center infrastructure layer 710, a framework layer 720, a software layer 730, and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R. s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R. s from among node C.R. s 716(1)-716(N) may be a server having one or more of above-mentioned computing resources.

In at least one embodiment, grouped computing resources 714 may include separate groupings of node C.R. s housed within one or more racks (not shown), or many racks housed in data centers at various geographical locations (also not shown). Separate groupings of node C.R. s within grouped computing resources 714 may include grouped compute, network, memory or storage resources that may be configured or allocated to support one or more workloads. In at least one embodiment, several node C.R. s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 712 may configure or otherwise control one or more node C.R. s 716(1)-716(N) and/or grouped computing resources 714. In at least one embodiment, resource orchestrator 712 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 722, a configuration manager 724, a resource manager 726 and a distributed file system 728. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may use distributed file system 728 for large-scale data processing (e.g., “big data”). In at least one embodiment, job scheduler 722 may include a Spark driver to facilitate scheduling of workloads supported by various layers of data center 700. In at least one embodiment, configuration manager 724 may be capable of configuring different layers such as software layer 730 and framework layer 720 including Spark and distributed file system 728 for supporting large-scale data processing. In at least one embodiment, resource manager 726 may be capable of managing clustered or grouped computing resources mapped to or allocated for support of distributed file system 728 and job scheduler 722. In at least one embodiment, clustered or grouped computing resources may include grouped computing resource 814 at data center infrastructure layer 710. In at least one embodiment, resource manager 726 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 728 of framework layer 720. The one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R s 716(1)-716(N), grouped computing resources 714, and/or distributed file system 728 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 724, resource manager 726, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underused and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. In at least one embodiment, inference and/or training logic 715 may be used in system FIG. 7 for inferencing or predicting operations based, at least in part, on weight parameters calculated using neural network training operations, neural network functions and/or architectures, or neural network use cases described herein.

Such components can be used for offloading workload data to available DPU memory to reduced GPU memory limitations during processing of workloads.

### COMPUTER SYSTEMS

FIG. 8 is a block diagram illustrating an exemplary computer system, which may be a system with interconnected devices and components, a system-on-a-chip (SOC) or some combination thereof 800 formed with a processor that may include execution units to execute an instruction, according to at least one embodiment. In at least one embodiment, computer system 800 may include, without limitation, a component, such as a processor 802 to employ execution units including logic to perform algorithms for process data, in accordance with present disclosure, such as in embodiment described herein. In at least one embodiment, computer system 800 may include processors, such as processing elementNTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 800 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 800 may include, without limitation, processor 802 that may include, without limitation, one or more execution units 808 to perform machine learning model training and/or inferencing according to techniques described herein. In at least one embodiment, computer system 800 is a single processor desktop or server system, but in another embodiment computer system 800 may be a multiprocessor system. In at least one embodiment, processor 802 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 802 may be coupled to a processor bus 810 that may transmit data signals between processor 802 and other components in computer system 800.

In at least one embodiment, processor 802 may include, without limitation, a Level 1 (“L1”) internal cache memory (“cache”) 804. In at least one embodiment, processor 802 may have a single internal cache or multiple levels of internal cache. In at least one embodiment, cache memory may reside external to processor 802. Other embodiments may also include a combination of both internal and external caches depending on particular implementation and needs. In at least one embodiment, register file 806 may store different types of data in various registers including, without limitation, integer registers, floating point registers, status registers, and instruction pointer register.

In at least one embodiment, execution unit 808, including, without limitation, logic to perform integer and floating point operations, also resides in processor 802. In at least one embodiment, processor 802 may also include a microcode (“ucode”) read only memory (“ROM”) that stores microcode for certain macro instructions. In at least one embodiment, execution unit 808 may include logic to handle a packed instruction set 809. In at least one embodiment, by including packed instruction set 809 in an instruction set of a general-purpose processor 802, along with associated circuitry to execute instructions, operations used by many multimedia applications may be performed using packed data in a general-purpose processor 802. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 808 may also be used in microcontrollers, embedded processors, graphics devices, DSPs, and other types of logic circuits. In at least one embodiment, computer system 800 may include, without limitation, a memory 820. In at least one embodiment, memory 820 may be implemented as a Dynamic Random Access Memory (“DRAM”) device, a Static Random Access Memory (“SRAM”) device, flash memory device, or other memory device. In at least one embodiment, memory 820 may store instruction(s) 819 and/or data 821 represented by data signals that may be executed by processor 802.

In at least one embodiment, system logic chip may be coupled to processor bus 810 and memory 820. In at least one embodiment, system logic chip may include, without limitation, a memory controller hub (“MCH”) 816, and processor 802 may communicate with MCH 816 via processor bus 810. In at least one embodiment, MCH 816 may provide a high bandwidth memory path 818 to memory 820 for instruction and data storage and for storage of graphics commands, data and textures. In at least one embodiment, MCH 816 may direct data signals between processor 802, memory 820, and other components in computer system 800 and to bridge data signals between processor bus 810, memory 820, and a system I/O 822. In at least one embodiment, system logic chip may provide a graphics port for coupling to a graphics controller. In at least one embodiment, MCH 816 may be coupled to memory 820 through a high bandwidth memory path 818 and graphics/video card 812 may be coupled to MCH 816 through an Accelerated Graphics Port (“AGP”) interconnect 814.

In at least one embodiment, computer system 800 may use system I/O 822 that is a proprietary hub interface bus to couple MCH 816 to I/O controller hub (“ICH”) 830. In at least one embodiment, ICH 830 may provide direct connections to some I/O devices via a local I/O bus. In at least one embodiment, local I/O bus may include, without limitation, a high-speed I/O bus for connecting peripherals to memory 820, chipset, and processor 802. Examples may include, without limitation, an audio controller 829, a firmware hub (“flash BIOS”) 828, a wireless transceiver 826, a data storage 824, a legacy I/O controller 823 containing user input and keyboard interface(s) 825, a serial expansion port 827, such as Universal Serial Bus (“USB”), and a network controller 834. Data storage 824 may comprise a hard disk drive, a floppy disk drive, a CD-ROM device, a flash memory device, or other mass storage device.

In at least one embodiment, FIG. 8 illustrates a system, which includes interconnected hardware devices or “chips”, whereas in other embodiments, FIG. 8 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 800 are interconnected using compute express link (CXL) interconnects.

Inference and/or training logic 715 are used to perform inferencing and/or training operations associated with one or more embodiments. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components can be used for offloading workload data to available DPU memory to reduced GPU memory limitations during processing of workloads.

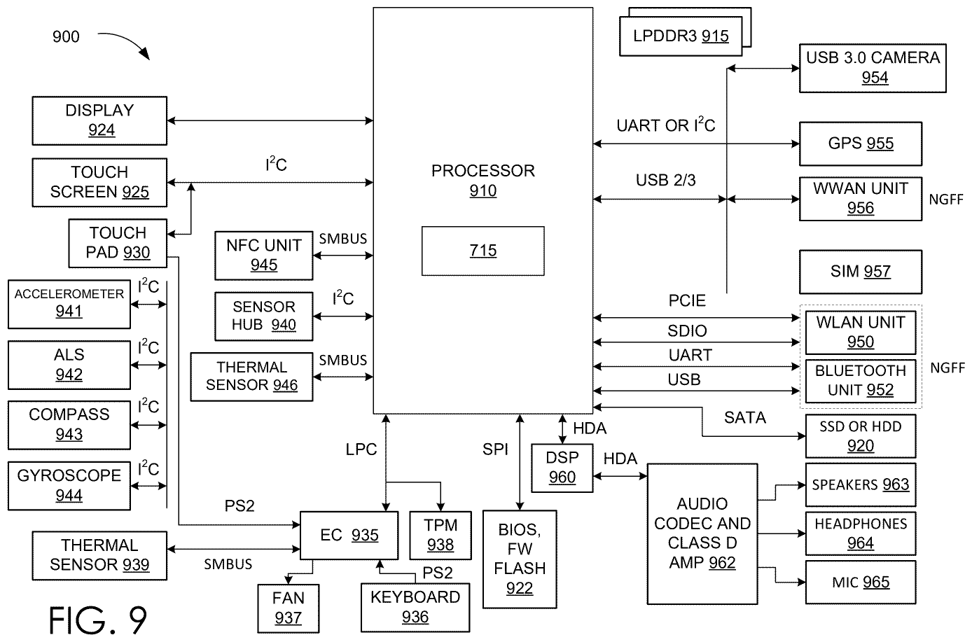

FIG. 9 is a block diagram illustrating an electronic device 900 for utilizing a processor 910, according to at least one embodiment. In at least one embodiment, electronic device 900 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 900 may include, without limitation, processor 910 communicatively coupled to any suitable number or kind of components, peripherals, modules, or devices. In at least one embodiment, processor 910 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices illustrated in FIG. 9 may be interconnected with proprietary interconnects, standardized interconnects (e.g., PCIe) or some combination thereof. In at least one embodiment, one or more components of FIG. 9 are interconnected using compute express link (CXL) interconnects.

In at least one embodiment, FIG. 9 may include a display 924, a touch screen 925, a touch pad 930, a Near Field Communications unit (“NFC”) 945, a sensor hub 940, a thermal sensor 946, an Express Chipset (“EC”) 935, a Trusted Platform Module (“TPM”) 938, BIOS/firmware/flash memory (“BIOS, FW Flash”) 922, a DSP 960, a drive 920 such as a Solid State Disk (“SSD”) or a Hard Disk Drive (“HDD”), a wireless local area network unit (“WLAN”) 950, a Bluetooth unit 952, a Wireless Wide Area Network unit (“WWAN”) 956, a Global Positioning System (GPS) 955, a camera (“USB 3.0 camera”) 954 such as a USB 3.0 camera, and/or a Low Power Double Data Rate (“LPDDR”) memory unit (“LPDDR3”) 915 implemented in, for example, LPDDR3 standard. These components may each be implemented in any suitable manner.

In at least one embodiment, other components may be communicatively coupled to processor 910 through components discussed above. In at least one embodiment, an accelerometer 941, Ambient Light Sensor (“ALS”) 942, compass 943, and a gyroscope 944 may be communicatively coupled to sensor hub 940. In at least one embodiment, thermal sensor 939, a fan 937, a keyboard 936, and a touch pad 930 may be communicatively coupled to EC 935. In at least one embodiment, speakers 963, headphones 964, and microphone (“mic”) 965 may be communicatively coupled to an audio unit (“audio codec and class d amp”) 962, which may in turn be communicatively coupled to DSP 960. In at least one embodiment, audio unit 962 may include, for example and without limitation, an audio coder/decoder (“codec”) and a class D amplifier. In at least one embodiment, SIM card (“SIM”) 957 may be communicatively coupled to WWAN unit 956. In at least one embodiment, components such as WLAN unit 950 and Bluetooth unit 952, as well as WWAN unit 956 may be implemented in a Next Generation Form Factor (“NGFF”).

Inference and/or training logic 715 are used to perform inferencing and/or training operations associated with one or more embodiments. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components can be used for offloading workload data to available DPU memory to reduced GPU memory limitations during processing of workloads.

FIG. 10 is a block diagram of a processing system, according to at least one embodiment. In at least one embodiment, system 1000 includes one or more processor(s) 1002 and one or more graphics processor(s) 1008, and may be a single processor desktop system, a multiprocessor workstation system, or a server system having a large number of processor(s) 1002 or processor core(s) 1007. In at least one embodiment, system 1000 is a processing platform incorporated within a system-on-a-chip (SoC) integrated circuit for use in mobile, handheld, or embedded devices.

In at least one embodiment, system 1000 can include, or be incorporated within a server-based gaming platform, a game console, including a game and media console, a mobile gaming console, a handheld game console, or an online game console. In at least one embodiment, system 1000 is a mobile phone, smart phone, tablet computing device or mobile Internet device. In at least one embodiment, processing system 1000 can also include, couple with, or be integrated within a wearable device, such as a smart watch wearable device, smart eyewear device, augmented reality device, or virtual reality device. In at least one embodiment, processing system 1000 is a television or set top box device having one or more processor(s) 1002 and a graphical interface generated by one or more graphics processor(s) 1008.

In at least one embodiment, one or more processor(s) 1002 each include one or more processor core(s) 1007 to process instructions which, when executed, perform operations for system and user software. In at least one embodiment, each of one or more processor core(s) 1007 is configured to process a specific instruction set 1009. In at least one embodiment, instruction set 1009 may facilitate Complex Instruction Set Computing (CISC), Reduced Instruction Set Computing (RISC), or computing via a Very Long Instruction Word (VLIW). In at least one embodiment, processor core(s) 1007 may each process a different instruction set 1009, which may include instructions to facilitate emulation of other instruction sets. In at least one embodiment, processor core(s) 1007 may also include other processing devices, such a Digital Signal Processor (DSP).

In at least one embodiment, processor(s) 1002 includes cache memory 1004. In at least one embodiment, processor(s) 1002 can have a single internal cache or multiple levels of internal cache. In at least one embodiment, cache memory is shared among various components of processor(s) 1002. In at least one embodiment, processor(s) 1002 also uses an external cache (e.g., a Level-3 (L3) cache or Last Level Cache (LLC)) (not shown), which may be shared among processor core(s) 1007 using known cache coherency techniques. In at least one embodiment, register file 1006 is additionally included in processor(s) 1002 which may include different types of registers for storing different types of data (e.g., integer registers, floating point registers, status registers, and an instruction pointer register). In at least one embodiment, register file 1006 may include general-purpose registers or other registers.

In at least one embodiment, one or more processor(s) 1002 are coupled with one or more interface bus(es) 1010 to transmit communication signals such as address, data, or control signals between processor(s) 1002 and other components in system 1000. In at least one embodiment, interface bus(es) 1010, in one embodiment, can be a processor bus, such as a version of a Direct Media Interface (DMI) bus. In at least one embodiment, interface bus(es) 1010 is not limited to a DMI bus, and may include one or more Peripheral Component Interconnect buses (e.g., PCI, PCI Express), memory busses, or other types of interface busses. In at least one embodiment processor(s) 1002 include an integrated memory controller 1016 and a platform controller hub 1030. In at least one embodiment, memory controller 1016 facilitates communication between a memory device and other components of system 1000, while platform controller hub (PCH) 1030 provides connections to I/O devices via a local I/O bus.

In at least one embodiment, memory device 1020 can be a dynamic random access memory (DRAM) device, a static random access memory (SRAM) device, flash memory device, phase-change memory device, or some other memory device having suitable performance to serve as process memory. In at least one embodiment memory device 1020 can operate as system memory for system 1000, to store data 1022 and instruction 1021 for use when one or more processor(s) 1002 executes an application or process. In at least one embodiment, memory controller 1016 also couples with an optional external graphics processor 1012, which may communicate with one or more graphics processor(s) 1008 in processor(s) 1002 to perform graphics and media operations. In at least one embodiment, a display device 1011 can connect to processor(s) 1002. In at least one embodiment display device 1011 can include one or more of an internal display device, as in a mobile electronic device or a laptop device or an external display device attached via a display interface (e.g., DisplayPort, etc.). In at least one embodiment, display device 1011 can include a head mounted display (HMD) such as a stereoscopic display device for use in virtual reality (VR) applications or augmented reality (AR) applications.

In at least one embodiment, platform controller hub 1030 enables peripherals to connect to memory device 1020 and processor(s) 1002 via a high-speed I/O bus. In at least one embodiment, I/O peripherals include, but are not limited to, an audio controller 1046, a network controller 1034, a firmware interface 1028, a wireless transceiver 1026, touch sensors 1025, a data storage device 1024 (e.g., hard disk drive, flash memory, etc.). In at least one embodiment, data storage device 1024 can connect via a storage interface (e.g., SATA) or via a peripheral bus, such as a Peripheral Component Interconnect bus (e.g., PCI, PCI Express). In at least one embodiment, touch sensors 1025 can include touch screen sensors, pressure sensors, or fingerprint sensors. In at least one embodiment, wireless transceiver 1026 can be a Wi-Fi transceiver, a Bluetooth transceiver, or a mobile network transceiver such as a 3G, 4G, or Long Term Evolution (LTE) transceiver. In at least one embodiment, firmware interface 1028 enables communication with system firmware, and can be, for example, a unified extensible firmware interface (UEFI). In at least one embodiment, network controller 1034 can enable a network connection to a wired network. In at least one embodiment, a high-performance network controller (not shown) couples with interface bus(es) 1010. In at least one embodiment, audio controller 1046 is a multi-channel high definition audio controller. In at least one embodiment, system 1000 includes an optional legacy I/O controller 1040 for coupling legacy (e.g., Personal System 2 (PS/2)) devices to system. In at least one embodiment, platform controller hub 1030 can also connect to one or more Universal Serial Bus (USB) controller(s) 1042 connect input devices, such as keyboard and mouse 1043 combinations, a camera 1044, or other USB input devices.

In at least one embodiment, an instance of memory controller 1016 and platform controller hub 1030 may be integrated into a discreet external graphics processor, such as external graphics processor 1012. In at least one embodiment, platform controller hub 1030 and/or memory controller 1016 may be external to one or more processor(s) 1002. For example, in at least one embodiment, system 1000 can include an external memory controller 1016 and platform controller hub 1030, which may be configured as a memory controller hub and peripheral controller hub within a system chipset that is in communication with processor(s) 1002.

Inference and/or training logic 715 are used to perform inferencing and/or training operations associated with one or more embodiments. In at least one embodiment portions or all of inference and/or training logic 715 may be incorporated into graphics processor(s) 1008. For example, in at least one embodiment, training and/or inferencing techniques described herein may use one or more of ALUs embodied in a graphics processor. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can be used for offloading workload data to available DPU memory to reduced GPU memory limitations during processing of workloads.

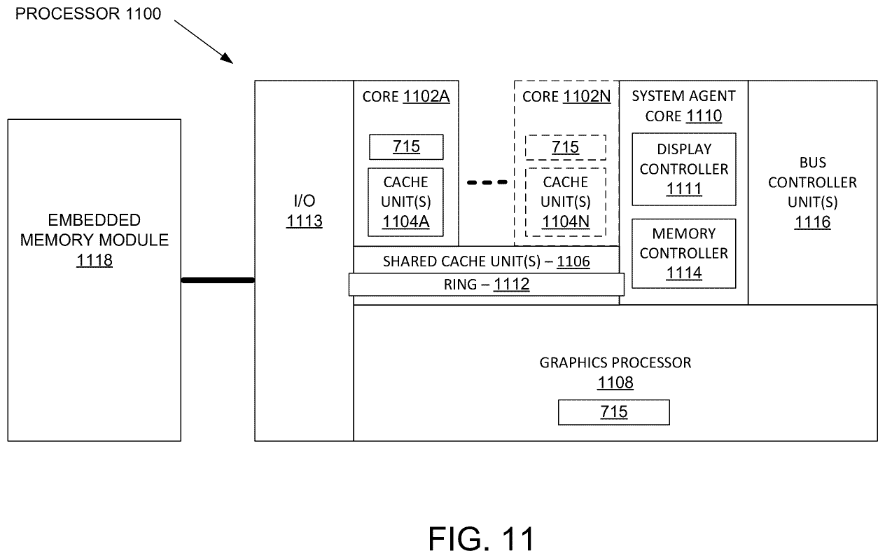

FIG. 11 is a block diagram of a processor 1100 having one or more processor core(s) 1102A-1102N, an integrated memory controller 1114, and an integrated graphics processor 1108, according to at least one embodiment. In at least one embodiment, processor 1100 can include additional cores up to and including additional core 1102N represented by dashed lined boxes. In at least one embodiment, each of processor core(s) 1102A-1102N includes one or more internal cache unit(s) 1104A-1104N. In at least one embodiment, each processor core also has access to one or more shared cached unit(s) 1106.

In at least one embodiment, internal cache unit(s) 1104A-1104N and shared cache unit(s) 1106 represent a cache memory hierarchy within processor 1100. In at least one embodiment, cache unit(s) 1104A-1104N may include at least one level of instruction and data cache within each processor core and one or more levels of shared mid-level cache, such as a Level 2(L2), Level 3(L3), Level 4(L4), or other levels of cache, where a highest level of cache before external memory is classified as an LLC. In at least one embodiment, cache coherency logic maintains coherency between various cache unit(s) 1106 and 1104A-1104N.

In at least one embodiment, processor 1100 may also include a set of one or more bus controller unit(s) 1116 and a system agent core 1110. In at least one embodiment, one or more bus controller unit(s) 1116 manage a set of peripheral buses, such as one or more PCI or PCI express busses. In at least one embodiment, system agent core 1110 provides management functionality for various processor components. In at least one embodiment, system agent core 1110 includes one or more integrated memory controllers 1114 to manage access to various external memory devices (not shown).

In at least one embodiment, one or more of processor core(s) 1102A-1102N include support for simultaneous multi-threading. In at least one embodiment, system agent core 1110 includes components for coordinating and operating processor core(s) 1102A-1102N during multi-threaded processing. In at least one embodiment, system agent core 1110 may additionally include a power control unit (PCU), which includes logic and components to regulate one or more power states of processor core(s) 1102A-1102N and graphics processor 1108.

In at least one embodiment, processor 1100 additionally includes graphics processor 1108 to execute graphics processing operations. In at least one embodiment, graphics processor 1108 couples with shared cache unit(s) 1106, and system agent core 1110, including one or more integrated memory controllers 1114. In at least one embodiment, system agent core 1110 also includes a display controller 1111 to drive graphics processor output to one or more coupled displays. In at least one embodiment, display controller 1111 may also be a separate module coupled with graphics processor 1108 via at least one interconnect, or may be integrated within graphics processor 1108.

In at least one embodiment, a ring based interconnect unit 1112 is used to couple internal components of processor 1100. In at least one embodiment, an alternative interconnect unit may be used, such as a point-to-point interconnect, a switched interconnect, or other techniques. In at least one embodiment, graphics processor 1108 couples with ring based interconnect unit 1112 via an I/O link 1113.

In at least one embodiment, I/O link 1113 represents at least one of multiple varieties of I/O interconnects, including an on package I/O interconnect which facilitates communication between various processor components and a high-performance embedded memory module 1118, such as an eDRAM module. In at least one embodiment, each of processor core(s) 1102A-1102N and graphics processor 1108 use embedded memory modules 1118 as a shared Last Level Cache.

In at least one embodiment, processor core(s) 1102A-1102N are homogenous cores executing a common instruction set architecture. In at least one embodiment, processor core(s) 1102A-1102N are heterogeneous in terms of instruction set architecture (ISA), where one or more of processor core(s) 1102A-1102N execute a common instruction set, while one or more other cores of processor core(s) 1102A-1102N executes a subset of a common instruction set or a different instruction set. In at least one embodiment, processor core(s) 1102A-1102N are heterogeneous in terms of microarchitecture, where one or more cores having a relatively higher power consumption couple with one or more power cores having a lower power consumption. In at least one embodiment, processor 1100 can be implemented on one or more chips or as an SoC integrated circuit.

Inference and/or training logic 715 are used to perform inferencing and/or training operations associated with one or more embodiments. In at least one embodiment portions or all of inference and/or training logic 715 may be incorporated into processor 1100. For example, in at least one embodiment, training and/or inferencing techniques described herein may use one or more of ALUs embodied in graphics processor 1108, processor core(s) 1102A-1102N, or other components in FIG. 11. In at least one embodiment, weight parameters may be stored in on-chip or off-chip memory and/or registers (shown or not shown) that configure ALUs of graphics processor 1100/1108 to perform one or more machine learning algorithms, neural network architectures, use cases, or training techniques described herein.

Such components can be used for offloading workload data to available DPU memory to reduced GPU memory limitations during processing of workloads.

Various embodiments can be described by the following clauses:
1. A method, comprising:
causing one or more interfaces to be defined between at least one graphics processing unit (GPU) and a pool of data processing unit (DPU) memory;
inserting a set of workload data, for a workload to be processed by the at least one GPU, into the pool of DPU memory;
assigning identifiers corresponding to individual data of the set of workload data; and
prefetching, using the identifiers, from the pool of DPU memory at least one of the individual data to process the workload.
2. The method of clause 1, wherein the set of workload data includes one or more model states used during a forward pass of the workload to train a machine learning model.
3. The method of clause 1, wherein the set of workload data includes one or more activation functions produced during a forward pass of the workload to train a machine learning model.
4. The method of clause 1, wherein the set of workload data includes a model checkpoint of a machine learning model to be trained as the workload, the method further comprising:
storing, using the pool of DPU memory, a copy of the set of workload data to a persistent location.
5. The method of clause 4, further comprising:
determining that the machine learning model training has failed;
receiving at least a portion of the prefetched set of workload data including the model checkpoint; and
causing the training of the machine learning model to be restarted from the model checkpoint.
6. The method of clause 1, wherein the one or more interfaces can be used to perform at least one of allgathers or reduce-scatters operations on the set of workload data.
7. The method of clause 1, wherein the pool of DPU memory includes one or more of DDR memory, on-board non-volatile memory express (NVMe) devices, or NVMe devices over fabric.
8. The method of clause 1, further comprising:
scaling the pool of DPU memory to reduce memory capacity loads on the at least one GPU.
9. A processor comprising:
one or more processing units to:
   receive one or more values for a workload to be completed using at least one graphics processing unit (GPU);
   generate an object-store interface to data processing unit (DPU) offered memory;
   cause, using the object-store interface, the one or more values to be inserted into the DPU offered memory;
   generate identifiers corresponding to individual values of the one or more values; and
   select, using the corresponding identifiers, from the DPU offered memory at least one of the individual values for completing the workload.
10. The processor of clause 9, wherein the pool of DPU memory includes a plurality of DPUs.
11. The processor of clause 9, wherein the one or more values include one or more model states used during a forward pass of the workload to train a machine learning model.
12. The processor of clause 9, wherein the one or more values include one or more activations produced during a forward pass of the workload to train a machine learning model.
13. The processor of clause 9, wherein the one or more values include a model checkpoint of a machine learning model to be trained as the workload, the one or more processing circuits are further to:
store, using the DPU, a copy of the one or more values to a persistent location.
14. The processor of clause 13, wherein the one or more processing circuits are further to:
determine that the machine learning model training has failed;
receive at least a portion of the selected individual values including the model checkpoint; and
cause the training of the machine learning model to be restarted from the model checkpoint.
15. The processor of clause 8, wherein the one or more values stored in the DPU offered memory include a first subset of checkpoints that change be transferred at a first frequency and include a second subset of checkpoints that change be transferred at a second frequency.
16. The processor of clause 8, wherein the one or more processing circuits are further to:
orchestrate, using the DPU offered memory, at least one transfer of at least a portion of the one or more values.
17. A distributed system, comprising:
one or more processors comprising processing circuitry to store workload data having individual identifiers to a pool of available data processing unit (DPU) memory using at least one interface, and to prefetch at least a portion of the workload data based on the individual identifiers to complete a plurality of graphics processing units (GPUs) computations for the workload.
18. The distributed system of clause 17, wherein the individual identifiers are assigned to subsets of the workload data.
19. The distributed system of clause 17, wherein the at least one interface can be used to perform memory access operations on the workload data.
20. The distributed system of clause 17, wherein the pool of available DPU memory includes one or more of DDR memory, on-board NVMe devices, or NVMe devices over fabric.
21. The distributed system of clause 17, wherein the distributed system is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system for performing operations for a conversational AI application;
a system for performing operations for a generative AI application;
a system for performing operations using a language model;
a system for performing one or more generative content operations using a large language model (LLM);
a system implemented at least partially in a data center;
a system for performing hardware testing using simulation;
a system for performing one or more generative content operations using a language model;
a system for synthetic data generation;
a collaborative content creation platform for 3D assets; or
a system implemented at least partially using cloud computing resources.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors-for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method, comprising:
causing one or more interfaces to be defined between at least one graphics processing unit (GPU) and a pool of data processing unit (DPU) memory;
inserting a set of workload data, for a workload to be processed by the at least one GPU, into the pool of DPU memory;
assigning identifiers corresponding to individual data of the set of workload data; and
prefetching, using the identifiers, from the pool of DPU memory at least one of the individual data to process the workload.

2. The method of claim 1, wherein the set of workload data includes one or more model states used during a forward pass of the workload to train a machine learning model.

3. The method of claim 1, wherein the set of workload data includes one or more activation functions produced during a forward pass of the workload to train a machine learning model.

4. The method of claim 1, wherein the set of workload data includes a model checkpoint of a machine learning model to be trained as the workload, the method further comprising:
storing, using the pool of DPU memory, a copy of the set of workload data to a persistent location.

5. The method of claim 4, further comprising:
determining that the machine learning model training has failed;
receiving at least a portion of the prefetched set of workload data including the model checkpoint; and
causing the training of the machine learning model to be restarted from the model checkpoint.

6. The method of claim 1, wherein the one or more interfaces can be used to perform at least one of allgathers or reduce-scatters operations on the set of workload data.

7. The method of claim 1, wherein the pool of DPU memory includes one or more of DDR memory, on-board non-volatile memory express (NVMe) devices, or NVMe devices over fabric.

8. The method of claim 1, further comprising:
scaling the pool of DPU memory to reduce memory capacity loads on the at least one GPU.

9. A processor comprising:
one or more processing units to:
receive one or more values for a workload to be completed using at least one graphics processing unit (GPU);
generate an object-store interface to data processing unit (DPU) offered memory;
cause, using the object-store interface, the one or more values to be inserted into the DPU offered memory;
generate identifiers corresponding to individual values of the one or more values; and
select, using the corresponding identifiers, from the DPU offered memory at least one of the individual values for completing the workload.

10. The processor of claim 9, wherein the pool of DPU memory includes a plurality of DPUs.

11. The processor of claim 9, wherein the one or more values include one or more model states used during a forward pass of the workload to train a machine learning model.

12. The processor of claim 9, wherein the one or more values include one or more activations produced during a forward pass of the workload to train a machine learning model.

13. The processor of claim 9, wherein the one or more values include a model checkpoint of a machine learning model to be trained as the workload, the one or more processing circuits are further to:
store, using the DPU, a copy of the one or more values to a persistent location.

14. The processor of claim 13, wherein the one or more processing circuits are further to:
determine that the machine learning model training has failed;
receive at least a portion of the selected individual values including the model checkpoint; and
cause the training of the machine learning model to be restarted from the model checkpoint.

15. The processor of claim 9, wherein the one or more values stored in the DPU offered memory include a first subset of checkpoints that change be transferred at a first frequency and include a second subset of checkpoints that change be transferred at a second frequency.

16. The processor of claim 9, wherein the one or more processing circuits are further to:
orchestrate, using the DPU offered memory, at least one transfer of at least a portion of the one or more values.

17. A distributed system, comprising:
one or more processors comprising processing circuitry to store workload data having individual identifiers to a pool of available data processing unit (DPU) memory using at least one interface, and to prefetch at least a portion of the workload data based on the individual identifiers to complete a plurality of graphics processing units (GPUs) computations for the workload.

18. The distributed system of claim 17, wherein the individual identifiers are assigned to subsets of the workload data.

19. The distributed system of claim 17, wherein the at least one interface can be used to perform memory access operations on the workload data.

20. The distributed system of claim 17, wherein the pool of available DPU memory includes one or more of DDR memory, on-board NVMe devices, or NVMe devices over fabric.

21. The distributed system of claim 17, wherein the distributed system is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system for performing operations for a conversational AI application;
a system for performing operations for a generative AI application;
a system for performing operations using a language model;
a system for performing one or more generative content operations using a large language model (LLM);
a system implemented at least partially in a data center;
a system for performing hardware testing using simulation;
a system for performing one or more generative content operations using a language model;
a system for synthetic data generation;
a collaborative content creation platform for 3D assets; or
a system implemented at least partially using cloud computing resources.
